(19) United States
(12) Patent Application Publication
(10) Pub. No.: US 2008/0073961 A1
(43) Pub. Date: Mar. 27, 2008

(54) Reclining mechanism for vehicle seats

(75) Inventors: Robert Wahls, Commerce Township, MI (US); James S. Wawrzyniak, Warren, MI (US); Kenneth McQueen, Leonard, MI (US); Luke Gajda, Royal Oak, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/520,336

(22) Filed: Sep. 12, 2006

(51) Int. Cl. B60N 2/02

(52) U.S. Cl. 297/367

(57) ABSTRACT

A reclining mechanism for a vehicle seat is disclosed with a guide plate pivotally connected to a pivotal plate, which has two internal gear segments. A cam is pivotally connected to the pivotal plate, and has a pair of pawls. Two lock elements are translatable relative to the guide plate, and have a gear segment to cooperate with the pivotal plate gear segments. Rotation of the cam engages each of the cam pawls with one of the engagement elements to unlock the gear segments from each of the pivotal plate gear segments. Springs cooperate with the guide plate and the cam for locking the mechanism. A bushing cooperates with the cam and receives a shaft for connecting the reclining mechanism to another reclining mechanism. A clip supports the bushing, but does not extend beyond an outer profile of one of the pivotal plate or guide plate.

### BACKGROUND OF THE INVENTION

1. Field of the Invention

The invention relates reclining mechanisms for vehicle seating assemblies.

2. Background Art

Reclining mechanisms for vehicle seats permit the seat back to pivot in two directions to allow a passenger to recline or incline the seat.

### BRIEF DESCRIPTION OF THE DRAWINGS

FIG. 1 is a perspective view of a seat assembly in accordance with the present invention;

FIG. 2 is an exploded perspective view of a reclining mechanism in accordance with the present invention;

FIG. 3 is an inboard elevation view of an assembled reclining mechanism in accordance with the present invention;

FIG. 4 is another inboard elevation view of a reclining mechanism partially assembled in a locked position in accordance with the present invention;

FIG. 5 is another inboard elevation view of a reclining mechanism partially assembled in a middle position in accordance with the present invention;

FIG. 6 is another inboard elevation view of a reclining mechanism partially assembled in an unlocked position in accordance with the present invention;

FIG. 7 is a cross-sectional view of a reclining mechanism in accordance with the present invention; and

FIG. 8 is an outboard elevation view of a reclining mechanism partially assembled in accordance with the present invention.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Referring now to FIG. 1, a seat assembly is illustrated and referenced generally by numeral 20. The seat assembly 20 typically include a generally horizontal member, which is used as a seat bottom 22. The seat assembly 20 also typically includes an upright member, which is used as a seat back 24. Connecting the seat bottom 22 to the seat back 24 are a pair of reclining mechanisms 26 for the illustrated embodiment. The pair of reclining mechanisms 26 are connected together by a shaft 28. The shaft 28 forces the pair of reclining mechanisms 26 to cooperate to lock or unlock the angle of the seat back 24 relative to the seat bottom 22.

In one embodiment, the pair of reclining mechanisms 26 each have a guide plate 30, which connects the reclining mechanism 26 to the seat bottom 22. The guide plate 30 connection to the seat bottom 22 is illustrated here by two connectors 31. Any suitable means of connecting the guide plate 30 to the seat bottom 22 is contemplated within the scope of the present invention such as a mechanical fastener to a seat frame.

The pair of reclining mechanisms 26 each have a pivotal plate 32 which connects the reclining mechanism 26 to the seat back 24. The pivotal plate 30 connection to the seat back 24 is illustrated here by two connectors 33. Any suitable means of connecting the pivotal plate 32 to the seat back 24 is contemplated within the scope of the present invention.

The guide plate 30 is pivotally connected to the pivotal plate 32 at the pivotal axis 34. The pivotal axis 34 may be located generally in the center of the guide plate 30 and the pivotal plate 32. The shaft 28 runs along the pivotal axis 34 and rotates about the pivotal axis 34. The pivotal plate 30 can rotate about the pivotal axis 34 and allows the seat back 24 to rotate about the pivotal axis 34 to recline or incline.

The reclining mechanism 26 may also have a bias spring 35 attached to the shaft 28. The bias spring 35 keeps the shaft 28 in a locked position from rotating until the lever 36 is raised. The lever 36 may be raised in one direction which overcomes the force of the bias spring 35 to allow for rotation of the shaft 28 about the pivotal axis 34.

With reference now to FIG. 2, an exploded view of the reclining mechanism 26 is shown. The reclining mechanism 26 may be generally housed within the guide plate 30 and the pivotal plate 32. A hub 38 may be inserted into the guide plate 30 about the pivotal axis 34. The hub 38 is sized to receive a shaft, such as the shaft 28 illustrated in FIG. 1, and is secured to the pivotal plate 32 by the clip 40. Neither the hub 38 nor the clip 40 extends beyond the outside housing of the pivotal plate 32, in one embodiment such as that illustrated in FIG. 7.

The cam 42 has a central bor which is sized the receive the hub 38. A clearance may exist between the outer diameter of the hub 38 and the inner diameter of the cam 42. When the hub 38 is rotated about the pivotal axis 34, the hub 38 causes the cam 42 to rotate due to corresponding splined configuration.

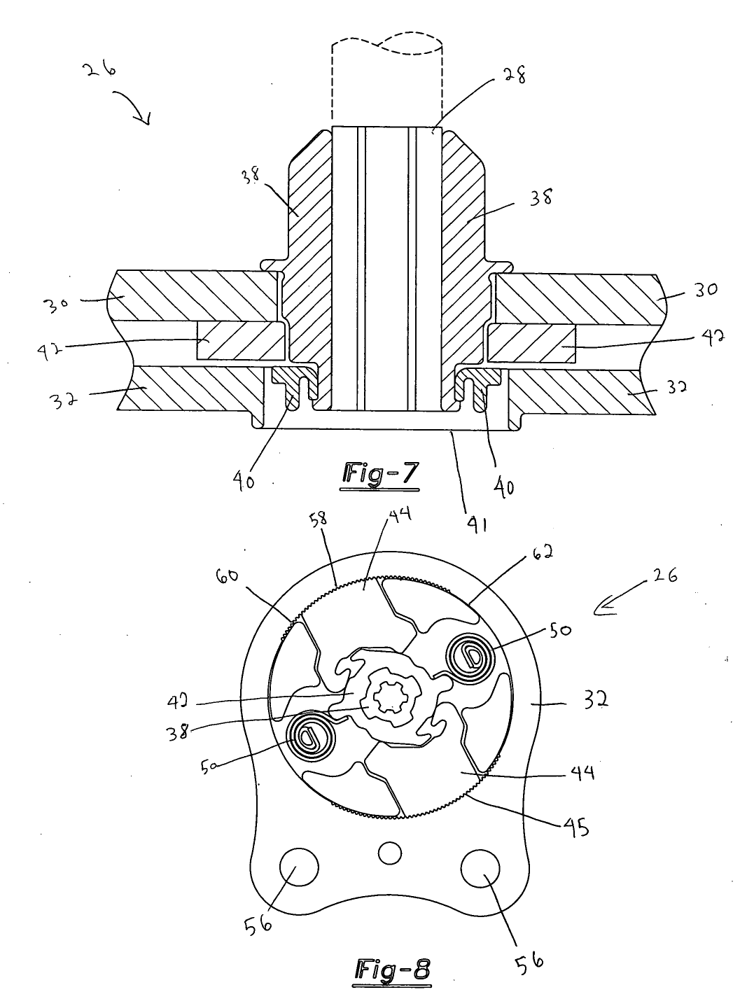

Referring to FIGS. 2 and 4-6, the cam 42 drives two lock elements 44. The lock elements 44 are shown opposite each other about the pivotal axis 34, for example. The guide plate 30 guides the lock elements 44 for translation in a radial direction. When an outer end 45 of one of the lock elements abuts the pivotal plate 32, the pivotal plate 32 is unable to rotate about the pivotal axis 34. When the outer end 45 is not in contact with the pivotal plate 32, the pivotal plate may rotate about the pivotal axis 34. The outer end 45 may have a gear segment 58 provided thereon, as illustrated. The gear segment on the outer end 45 communicates with the gear segment that may be provided on the inside of the pivotal plate 32 as illustrated in FIG. 8.

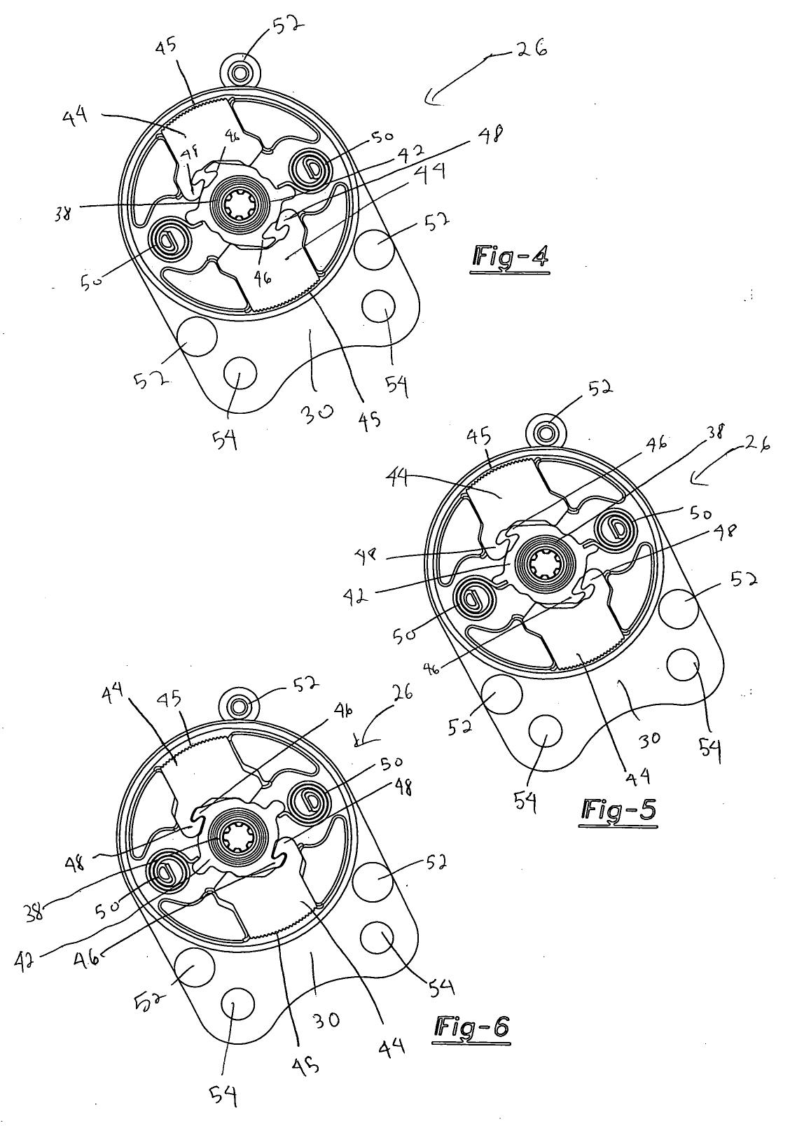

In an embodiment, the cam 42 has a cam pawl 46 and the lock elements 44 each have an associated lock pawl 48. When the cam pawl 48 does not engage the lock pawl 48, the cam pawl 46 drives the lock element 44 outward so that the outer end 45 is in contact with the pivotal plate 32. When the cam 42 rotates counterclockwise about the pivotal axis 34, illustrated sequentially from FIG. 4 though FIG. 6, the cam pawl 46 hooks the lock pawl 48, which pulls the lock element 44 toward the pivotal axis 34. When the lock element 44 is pulled toward the pivotal axis 34, the outer end of the lock element 45 is no longer in contact with the pivotal plate 32, which thereby allows the pivotal plate 32 and the associated seat back 24 to rotate about the pivotal axis 34.

In the embodiment illustrated, a pair of torsion springs 50 are each connected to the guide plate 38 and the cam 42. The springs 50 urge the cam 42 in a direction urging the lock elements 44 outward into engagement with pivotal plate 32.

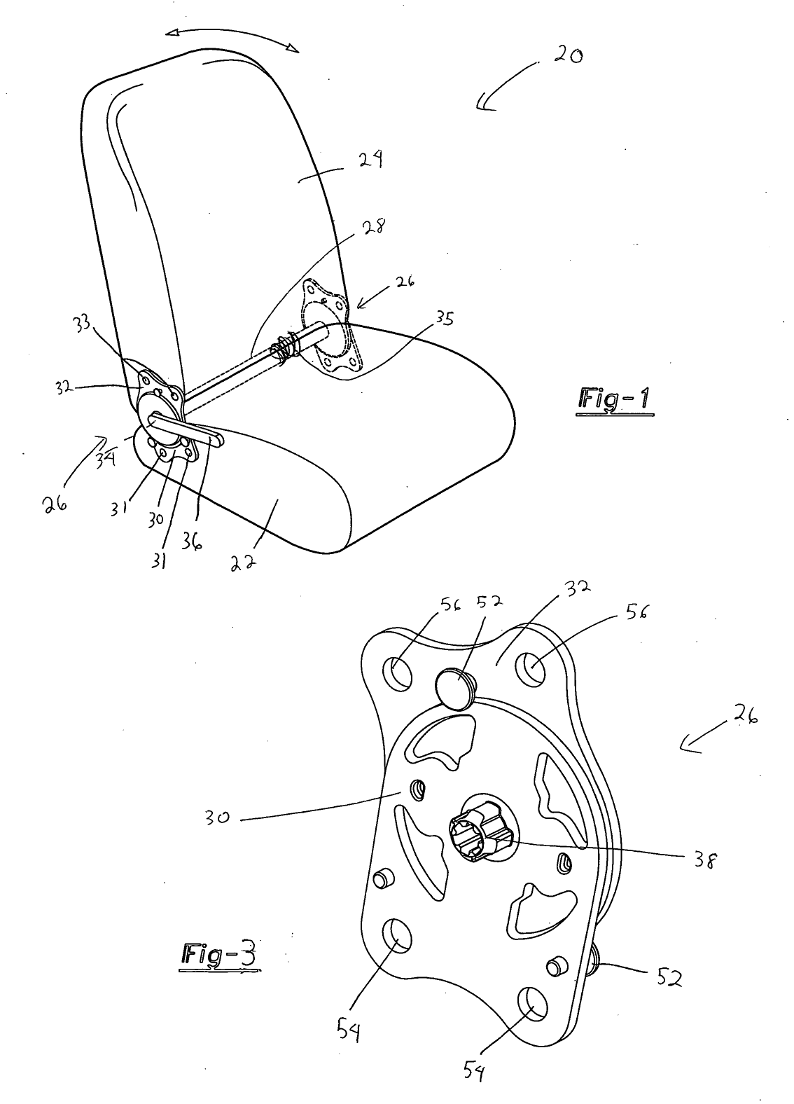

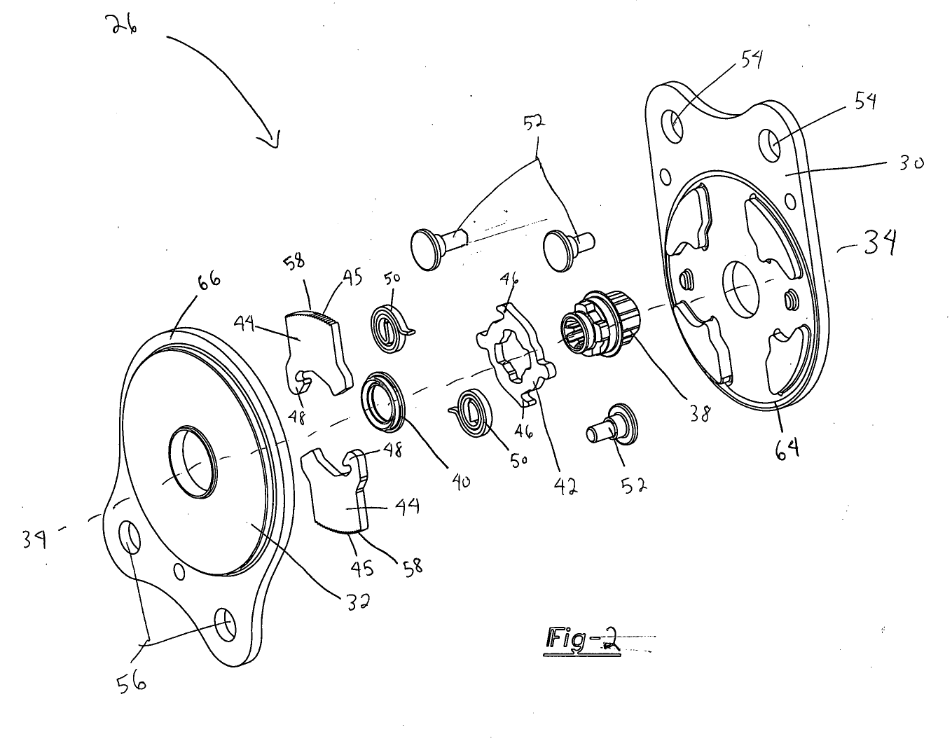

With reference to FIGS. 2 and 3, retainers 52 are connected through the guide plate 30 and the pivotal plate 32 to allow rotational movement of the pivotal plate 32 about the pivotal axis 34 while restricting movement in a transverse direction. At least one retainer 52 on the pivotal plate 32 overlaps in a peripheral arcuate segment 64 of the guide plate to hold the guide plate 30. At least one retainer 52 on the guide plate 30 overlaps the peripheral arcuate segment 66 on the pivotal plate 32. This mechanism allows limited rotation of the guide plate 30 relitve to pivotal plate 32 about the pivotal axis 34.

Guide plate holes 54 are illustrated on the guide plate 30. The guide plate holes 54 allow the guide plate 30 to be connected to a seat bottom 22, as illustrated in FIG. 1. Pivotal plate holes 56 are illustrated on the pivotal plate 32. The pivotal plate holes 56 allow the pivotal plate 32 to be connected to a seat back 24, as shown in FIG. 1. The number of guide plate holes 54 and pivotal plate holes illustrated here is not a limitation on the present invention, as any amount of holes are contemplated within the scope of the present invention.

Referring now to FIG. 3, an outboard elevation view of the assembled reclining mechanism 26 is shown. The guide plate 30 is shown connected to the pivotal plate 32. The hub 38 connects through the guide plate 30 and the pivotal plate 32. A retainer 52 it shown in communication with the guide plate 30 and the pivotal plate 32.

With reference now to FIG. 4, a partially assembled reclining mechanism 26 is illustrated in a locked position. The guide plate 30 is shown with the hub 38 in connection with the cam 42 which drives the lock elements 44 outward into the locked position.

With reference now to FIG. 5, the partially assembled reclining mechanism 26 is shown in an intermediate position. The guide plate 30 is shown with the hub 38 in connection with the cam 42 which is partially engaged with the lock element 44.

Referring now to FIG. 6, the partially assembled reclining mechanism 26 is illustrated in an unlocked position. The guide plate 30 is shown with the hub 38 in connection with the cam 42 which is engaged with the lock element 44. The outer end of the lock element 45 does not abut the pivotal plate 32, which would allow for the rotation of the pivotal plate 32. The lock element 45 has been urged radially inward to unlock the pivotal plate 32. Since the pivotal plate 32 would be able to rotate, the reclining mechanism 26 would be in an unlocked position.

With reference now to FIG. 7, an enlarged partial cross-sectional view of a reclining mechanism is illustrated and referenced generally by numeral 26. A shaft 28 is in communication with the hub 38. The hub 38 is secured on one side by the guide plate 30 by a shoulder or step and on another side by a retaining clip 40. Neither the hub 38 nor the clip 40 extends beyond the outer profile 41 of the pivotal plate 32 for compactness. The cam 42 is positioned between the guide plate 30 and the pivotal plate 32. Alternatively, the guide plate 30 and the pivotal plate 32 may switch positions with the hub 38 mounted to the pivotal plate 32.

Referring now to FIG. 8, the partially assembled reclining mechanism 26 is shown. The pivotal plate 32 is shown in communication with the lock elements 44. The outer end of the lock elements 45 include a gear segment 58 on it, which interact with an internal gear segment 60 of the pivotal plate 32. The internal gear segment 60 of the pivotal plate 32 is positioned on the inside lip 62 of the pivotal plate 32. When the lock element 45 is engaged with the pivotal plate 32, the pivotal plate 32 cannot rotate.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A reclining mechanism for a vehicle seat comprising:
a guide plate adapted to be secured to one of a seat bottom or a seat back;
a pivotal plate adapted to be secured to the other of the seat bottom or seat back pivotally connected to the guide plate about a pivotal axis, the pivotal plate having two internal gear segments provided therein;
a cam pivotally connected to the pivotal plate, the cam providing at least two cam pawls;
two lock elements cooperating with the guide plate and the cam for translation relating to the guide plate, the lock elements each having a gear segment provided radially outward thereon to each cooperate with one of the pivotal plate gear segments, the lock elements each providing an engagement element for cooperation with the cam pawl, wherein rotation of the cam engages each of the cam pawls with one of the engagement elements to urge inward radial movement of the locking elements which unlocks each of the locking element gear segments from each of the pivotal plate gear segments;
two springs cooperating with the guide plate and the cam for urging the cam to translate the lock element gear segments into engagement with the pivotal plate gear segments;
a bushing cooperating with the cam for rotation about the pivotal axis, the bushing being sized to receive a shaft for connecting the reclining mechanism to a second reclining mechanism; and
a clip supporting the bushing, the clip and the bushing not extending beyond an outer profile of one of the pivotal plate or guide plate.

2. The reclining mechanism of claim 1 further comprising:
at least one retainer connected through the guide plate and the pivotal plate, the one retainer overlapping along a peripheral arcuate segment of the guide plate to hold the guide plate to the pivotal plate while limiting separation; and
at least two retainers connected through the guide plate and the pivotal plate, the two retainers overlapping along a peripheral arcuate segment of the pivotal plate to hold the pivotal plate to the guide plate while limiting separation.

3. The reclining mechanism of claim 1 further comprising:
at least two retainers connected through the guide plate and the pivotal plate, the two retainers overlapping along a peripheral arcuate segment of the guide plate to hold the guide plate to the pivotal plate while limiting separation; and
at least one retainer connected through the guide plate and the pivotal plate, the one retainer overlapping along a peripheral arcuate segment of the pivotal plate to hold the pivotal plate to the guide plate while limiting separation.

4. The reclining mechanism of claim 1 wherein the cam, which has an inner diameter, is sized to receive the bushing, which has an outer diameter, such that a clearance is provided between the outer diameter of the bushing and an inner diameter of the cam.

5. The reclining mechanism of claim 1 wherein when each of the lock element gear segments are not engaged with one of the pivotal plate gear segments, the movement of the pivotal plate is not restricted.

6. The reclining mechanism of claim 1 wherein the bushing is supported on an opposite side by the cam.

7. A reclining system for use in a vehicle comprising:
a pair of reclining mechanisms each including:
a guide plate adapted to be secured to one of a seat bottom or a seat back,
a pivotal plate adapted to be secured to the other of the seat bottom or seat back pivotally connected to the guide plate about a pivotal axis, the pivotal plate having two internal gear segments provided therein,
a cam pivotally connected to the pivotal plate, the cam providing at least two cam pawls,
two lock elements cooperating with the guide plate and the cam for translation relating to the guide plate, the lock elements each having a gear segment provided radially outward thereon to each cooperate with one of the pivotal plate gear segments, the lock elements each providing an engagement element for cooperation with the cam pawl, wherein rotation of the cam engages each of the cam pawls with one of the engagement elements to urge rotation of the locking elements which unlocks each of the locking element gear segments from each of the pivotal plate gear segments,
two springs cooperating with the guide plate and the cam for urging the cam to translate the lock element gear segments into engagement with the pivotal plate gear segments,
a bushing cooperating with the cam for rotation about the pivotal axis, the bushing being sized to receive a shaft for connecting the reclining mechanism to a second reclining mechanism, and
a clip supporting the bushing, the clip and the bushing not extending beyond an outer profile of one of the pivotal plate or guide plate; and
a shaft which engages the bushings of the pair of reclining mechanisms to force cooperation between the pair of reclining mechanisms;
wherein the shaft is manually rotated, which rotates each of the bushings which causes each of the cams to rotate, which engages each of the cam pawls with each of the engagement elements to pull each of the two lock elements to unlock each of the pivotal plates to allow of the movement of each of the pivotal plates.

8. The reclining system of claim 7 further comprising:
a bias spring in cooperation with the shaft; and
a lever attached to the shaft;
wherein the lever may be pressed in one direction which releases the bias spring to allow for rotation of the shaft in one direction.

9. The reclining system of claim 7 further comprising:
at least one retainer connected through each of either the guide plates and the pivotal plates, the one retainer overlapping along a peripheral arcuate segment of each of the guide plates to hold each of the guide plates to each of the pivotal plates while limiting separation; and
at least two retainers connected through each of either the guide plates and the pivotal plates, the two retainers overlapping along a peripheral arcuate segment of each of the pivotal plates to hold each of the pivotal plates to each of the guide plates while limiting separation.

10. The reclining system of claim 7 further comprising:
at least two retainers connected through each of the guide plates and the pivotal plates, the two retainers overlapping along a peripheral arcuate segment of each of the guide plates to hold each of the guide plates to each of the pivotal plates while limiting separation; and
at least one retainer connected through each of the guide plates and the pivotal plates, the one retainer overlapping along a peripheral arcuate segment of each of the pivotal plates to hold each of the pivotal plates to each of the guide plates while limiting separation.

11. The reclining system of claim 7 wherein each of the cams, which each has an inner diameter, is sized to receive each of the bushings, which each has an outer diameter, such that a clearance is provided between the outer diameter of each of the bushings and an inner diameter each of the cams.

12. The reclining system of claim 7 wherein when each of the lock element gear segments is not engaged with one of the pivotal plate gear segments, the movement of the pivotal plate is not restricted.

13. The reclining system of claim 7 wherein each of the bushings is supported on an opposite side by each of the cams.

14. A seat assembly for use in a vehicle comprising:
a seat bottom;
a seat back;
a pair of reclining mechanisms each including:
a guide plate adapted to be secured to the seat bottom,
a pivotal plate adapted to be secured to the seat back which is pivotally connected to the guide plate about a pivotal axis, the pivotal plate having two internal gear segments provided thereon,
a cam pivotally connected to the pivotal plate, the cam providing at least two cam pawls,
two lock elements cooperating with the guide plate and the cam for translation relating to the guide plate, the lock elements each having a gear segment provided radially outward thereon to each cooperate with one of the pivotal plate gear segments, the lock elements each providing an engagement element for cooperation with the cam pawl, wherein rotation of the cam engages each of the cam pawls with one of the engagement elements to urge rotation of the locking elements which unlocks each of the locking element gear segments from each of the pivotal plate gear segments,
two springs cooperating with the guide plate and the cam for urging the cam to translate the lock element gear segments into engagement with the pivotal plate gear segments,
a bushing cooperating with the cam for rotation about the pivotal axis, the bushing being sized to receive a shaft for connecting the reclining mechanism to a second reclining mechanism, and
a clip supporting the bushing, the clip and the bushing not extending beyond an outer profile of one of the pivotal plate or guide plate; and
a shaft which engages the bushings of the pair of reclining mechanisms to force cooperation between the pair of reclining mechanisms;
wherein the shaft is manually rotated which rotates each of the bushings which causes each of the cam to rotate which engages each of the cam pawls with each of the engagement elements to pull each of the two lock elements to unlock each of the pivotal plates to allow of the movement of each of the pivotal plates whereby allowing an incline or reline of the seat back.

15. The seat assembly for use in a vehicle of claim 14 further comprising:
a bias spring connected to the shaft; and
a lever attached to the shaft;
wherein the lever may be pressed in one direction which releases the bias spring to allow for rotation of the shaft in one direction.

16. The seat assembly of claim 14 further comprising:
at least one retainer connected through each of either the guide plates and the pivotal plates, the one retainer overlapping along a peripheral arcuate segment of each of the guide plates to hold each of the guide plates to each of the pivotal plates while limiting separation; and
at least two retainers connected through each of either the guide plates and the pivotal plates, the two retainers overlapping along a peripheral arcuate segment of each of the pivotal plates to hold each of the pivotal plates to each of the guide plates while limiting separation.

17. The seat assembly of claim 14 further comprising:
at least two retainers connected through each of the guide plates and the pivotal plates, the two retainers overlapping along a peripheral arcuate segment of each of the guide plates to hold each of the guide plates to each of the pivotal plates while limiting separation; and
at least one retainer connected through each of the guide plates and the pivotal plates, the one retainer overlapping along a peripheral arcuate segment of each of the pivotal plates to hold each of the pivotal plates to each of the guide plates while limiting separation.

18. The seat assembly of claim 14 wherein each of the cams, which each has an inner diameter, is sized to receive each of the bushings, which each has an outer diameter, such that a clearance is provided between the outer diameter of each of the bushings and an inner diameter each of the cams.

19. The seat assembly of claim 14 wherein when each of the lock element gear segments is not engaged with each of the pivotal plate gear segments, the movement of the seat back is not restricted.

20. The seat assembly of claim 14 wherein each of the bushings is supported on an opposite side by each of the cams.
